(19) United States
(12) Patent Application Publication
(10) Pub. No.: US 2011/0067514 A1
(43) Pub. Date: Mar. 24, 2011

(54) ROBOT ARM ASSEMBLY AND INDUSTRIAL ROBOT USING THE SAME

(75) Inventor: Bo Long, Shenzhen City (CN)

(73) Assignees: HONG FU JIN PRECISION INDUSTRY( ShenZhen) CO., LTD, Shenzhen City (CN); HON HAI PRECISION INDUSTRY CO., LTD., Tu-Cheng (TW)

(21) Appl. No.: 12/632,955

(22) Filed: Dec. 8, 2009

(30) Foreign Application Priority Data
Sep. 24, 2009 (CN) 200910307655.2

(51) Int. Cl. B25J 18/00; F16H 3/00

(52) U.S. Cl. 74/420; 74/490.01

(57) ABSTRACT

A robot arm assembly includes a supporting arm, an Nth axle pivotally connected to the supporting arm, an (N+1)th axle pivotally and perpendicularly connected to the Nth axle, a first motor, a first gear transmission, a second motor, a second gear transmission and a control device. The first and second gear transmissions are multi-stage gear transmissions. The first gear transmission includes a first bevel gear coaxially aligned with and rigidly connected to the Nth axle, the second gear transmission includes a second bevel gear coaxially aligned with and rigidly connected to the (N+1)th axle. As the Nth axle rotates around the axis of the Nth axle, the (N+1)th axle rotates around the axis of the (N+1)th axle to compensate a following rotation error caused by following the rotation of the Nth axle.

### BACKGROUND

1. Technical Field

The present disclosure generally relates to robot arm assemblies, and particularly to a robot assembly for an industrial robot with multi-stage gear transmissions.

2. Description of Related Art

A commonly used industrial robot includes a fixed base, a frame pivotally connected thereto about a first axis, a lower arm, one end of which is pivotally connected to the frame about a second axis, and an upper arm, one end of which is pivotally connected to the other end of the lower arm about a third axis. An end effector, such as a welding device, a gripper, or a cutting tool, is mounted at a distal end of the upper arm of the industrial robot to execute specific tasks. Generally six axes are utilized to achieve maximum movement of the end effectors.

In typical robots of this kind, each arm of the robots rotates around a rotating axis driven by a driven unit. Typically, the driven unit includes a motor mounted on a first arm and a speed reducer coupled to the motor to transmit the movement of the motor to a second arm. The speed reducer may be a high gear ratio gear, such as a harmonic gear reducer, a RV reducer (rotary vector reducer), or a planetary reducer. The motor and the speed reducer are arranged along the rotating axis of the arm, rendering the range along the rotating axis relatively large. In a six-axis industrial robot, the fifth axle is rotatably connected to the sixth axle and may be perpendicularly positioned. The fifth and sixth axles are respectively driven by two driven units arranged adjacent to each other, such that the whole size of the fifth and sixth axles is relatively large. As a result, the industrial robots need considerable space to operate freely and safely.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a plan view of one embodiment of an industrial robot, having a robot assembly and six rotating axes.

FIG. 2 is an isometric of one embodiment of a robot arm assembly, utilized in an industrial robot, such as, for example, that of FIG. 1.

FIG. 3 is an isometric lateral cross section of the robot arm assembly of FIG. 2.

FIG. 4 is an enlarged detail appearing in FIG. 3.

### DETAILED DESCRIPTION

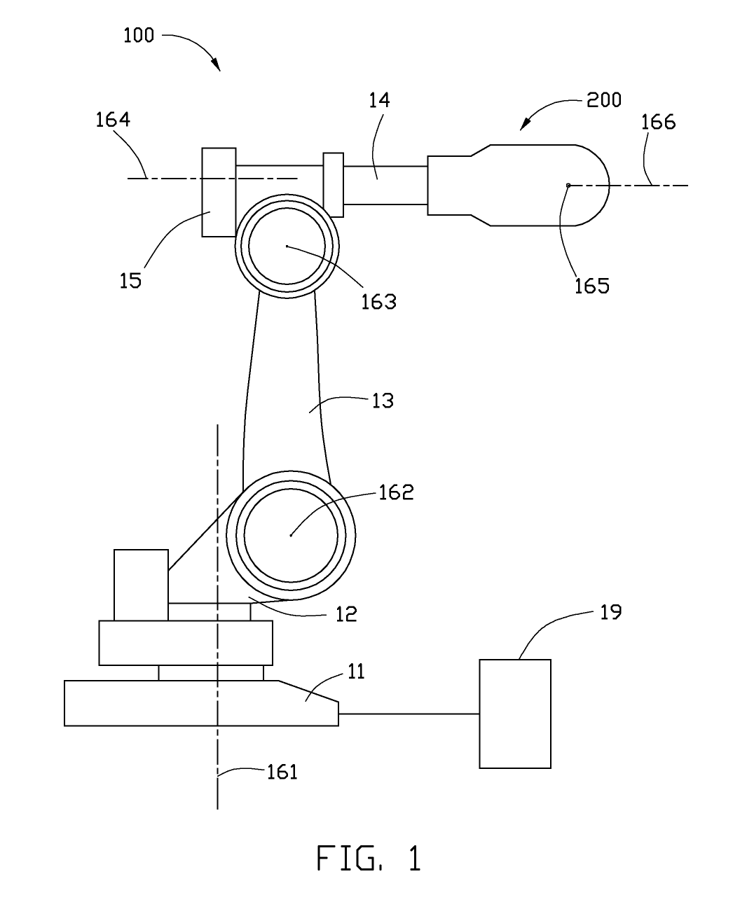

Referring to FIG. 1, one embodiment of an industrial robot 100 may be a six-axis industrial robot. The industrial robot 100 includes a base seat 11, a bracket 12 pivotally connected to the base seat 11, a first arm 13 pivotally connected to the bracket 12, a joint portion 15 pivotally connected to the first arm 13, and a second arm 14 pivotally connected to the joint portion 15.

The industrial robot 100 has six rotating axes. The bracket 12 is rotatable around a first axis 161. The first arm 13, the joint portion 15 and the second arm 14, are rotatable around second, third, and fourth axes 162, 163, and 164, respectively. The industrial robot 100 further includes a fifth axle 165, a sixth axle 166, and a control device 19 to control the movement of the industrial robot 100. An end effector (not shown), such as a clamp, a cutter, or a detector is generally positioned on a distal end of the sixth axle 166 to complete various operations.

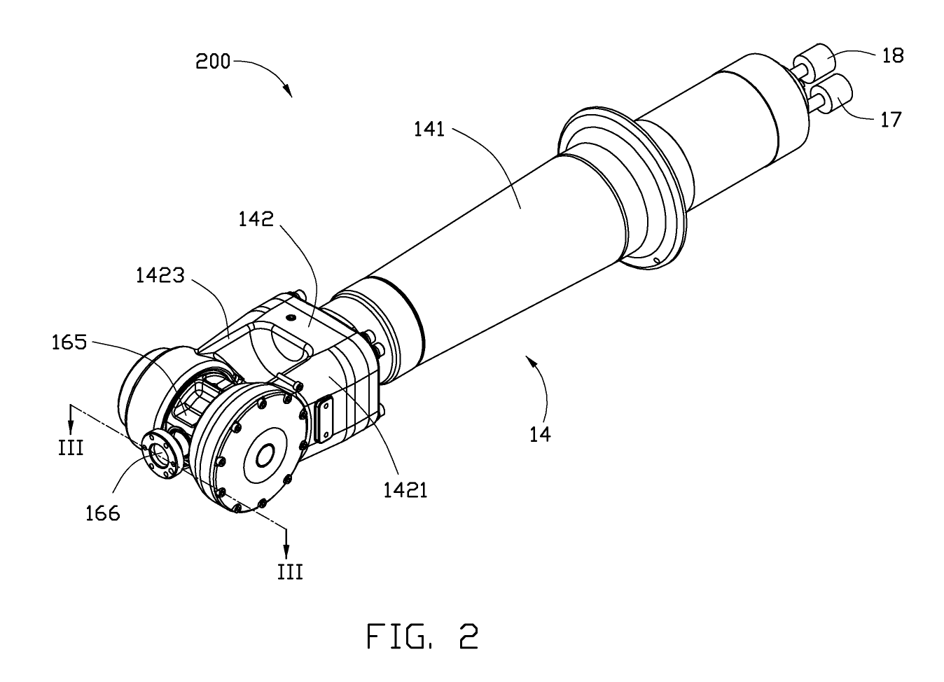

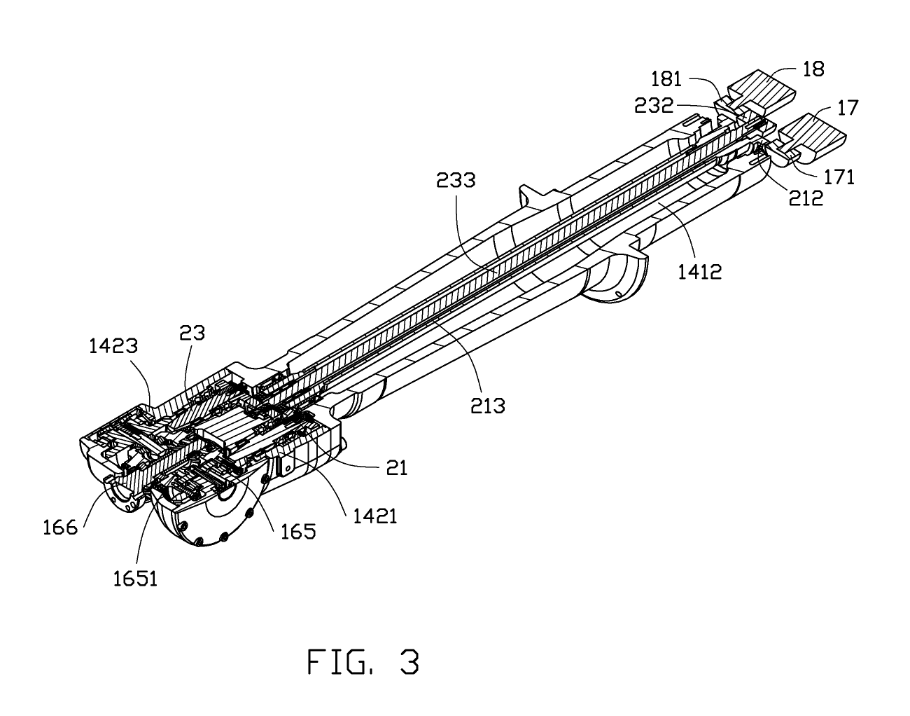

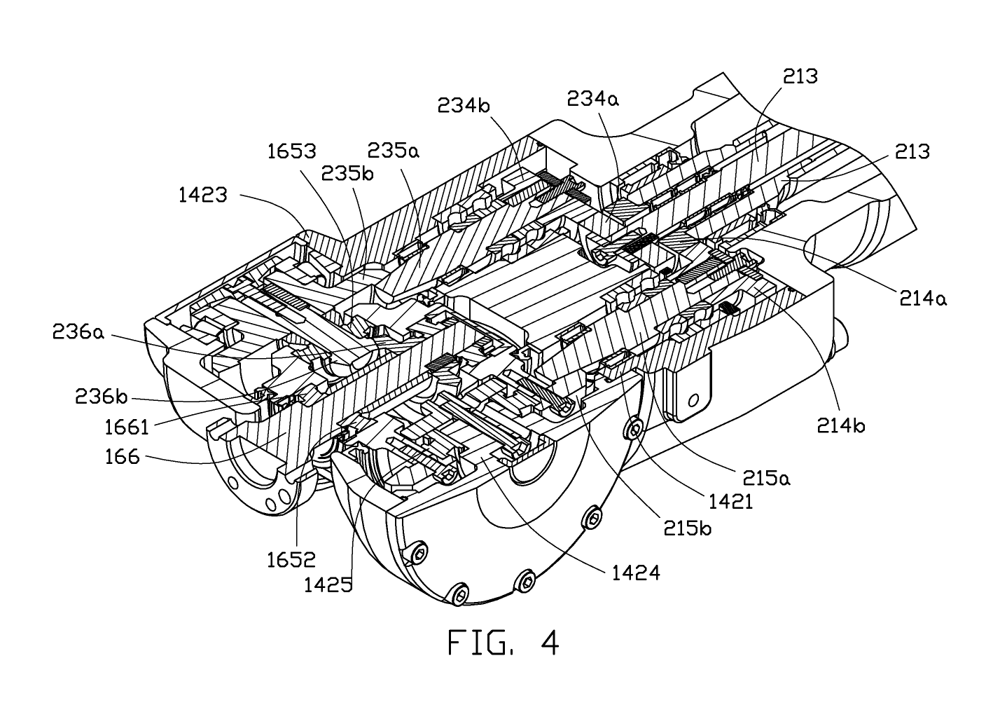

Referring to FIG. 2 through FIG. 4, one embodiment of a robot arm assembly 200 is included in an industrial robot, such as the industrial robot 100 described above. The robot arm assembly 200 includes the second arm 14, the fifth axle 165 pivotally connected to an end of the second arm 14, the sixth axle 166 pivotally connected to the fifth axle 165, a first motor 17, a first gear transmission 21 to drive the fifth axle 165, a second motor 18, a second gear transmission 23 to drive the sixth axle 166, and the control device 19 to control the first and second motors 17, 18. The first and second motors 17, 18 may provide rotation of the fifth and sixth axles 156, 166 respectively, via the first and second gear transmissions 21, 23 respectively. The first and second gear transmissions 21, 23 are both multi-stage gear transmissions.

The second arm 14 is hollow with a substantially fork-like extension. The second arm 14 includes a connecting portion 141 and a supporting portion 142 connected to an end of the connecting portion 141. The first and second gear transmissions 21, 23, and the fifth axle 165 can be received in the inner space of the second arm 14. The connecting portion 141 is substantially cylindrical and has a hollow portion 1412. The supporting portion 142 includes a first supporting wall 1421 in which the fifth axle 165 is supported, and a second supporting wall 1423 provided at a predetermined distance apart from the first supporting wall 1421. The first and second supporting walls 1421, 1423 extend substantially in parallel and are located on opposite sides of the connecting portion 141. A connecting base 1424 is formed on the first supporting wall 1421 extending substantially perpendicularly to the first supporting wall 1421.

The fifth axle 165 is pivotally connected to the connecting base 1424 and rotatably supported by a bearing 1425 placed in the second arm 14. The fifth axle 165 includes an output shaft 1651 whose pivotal axis is substantially perpendicular to the first or second supporting wall 1421, 1423. The output shaft 1651 defines a first shaft hole 1652 and a second shaft hole 1653 substantially perpendicular to and communicating with the first shaft hole 1652. The center axis of the second shaft hole 1652 and the rotating axis of the fifth axle 165 are substantially aligned along a common axis.

The first gear transmission 21 is positioned between the first motor 17 and the fifth axle 165. The first gear transmission 21 includes a first input gear 212, a first transmission shaft 213, a pair of first spur gears 214a, 214b, and a pair of first bevel gears 215a, 215b combined in series.

The first transmission shaft 213 is hollow and substantially cylindrical. The first transmission shaft 213 is rotatably received in the hollow portion 1412 of the second arm 14 and supported by bearings (not labeled) placed in the hollow potion 1412. The first input gear 212 is mounted at an end of the first transmission shaft 14 away from the fifth axle 165, and coupled to an output gear 171 of the first motor 17. The first spur gear 214a is secured to an end of the first transmission shaft 213 adjacent to the fifth axle 165. The first bevel gear 215a and the first spur gear 214b are aligned along a common axis and rigidly connected. The first bevel gear 215b and the output shaft 1651 are aligned along a common axis and rigidly connected, such that the fifth axle 165 can rotate as the first bevel gear 215b rotates.

The second gear transmission 23 is positioned between the second motor 18 and the sixth axle 166. The second gear transmission 23 includes a second input gear 232, a second transmission shaft 233, a pair of second spur gears 234a, 234b, a pair of third bevel gears 235a, 235b, and a pair of second bevel gears 236a, 236b combined in series.

The second transmission shaft 233 is substantially cylindrical and rotatably received in the first transmission shaft 213 with two ends extending out therefrom. The second transmission shaft 233 is rotatably supported by one or more bearings (not labeled) between an inner circumference of the first transmission shaft 213 and an outer circumference of the second transmission shaft 233. The second input gear 232 is mounted at an end of the second transmission shaft 233 away from the fifth axle 165, and coupled to an output gear 181 of the second motor 18. The first and second input gears 212, 232 are offset from each other in an axial direction. The first and second motors 17, 18 are positioned on opposite sides of the transmissions 213, 233 along the axial direction thereof to couple to the first and second gear transmissions 21, 23. The second spur gear 234a is secured to an end of the second transmission shaft 233 adjacent to the fifth axle 165. The pair of second spur gears 234a, 234b and the pair of first spur gears 214a, 214b are offset from each other in an axial direction. The third bevel gear 235a and the second spur gear 234b are aligned along a common axis and rigidly connected. The third bevel gears 235a and the first bevel gear 215a may be located on opposite sides of the first transmission shaft 213 along the axial direction. The second and third bevel gears 236a, 235b are substantially aligned along a common axis. The second bevel gear 236b is substantially coaxially aligned with the sixth axle 166 and rigidly connected to an end thereof. The second bevel gear 236b can be received in the first shaft hole 1652 of the fifth axle 165.

The first and second input gears 212, 232, the first and second spur gears 214a, 214b, 234a, 234b, the first bevel gears 215a, 215b, the second bevel gears 236a, 236b and the third bevel gears 235a, 235b are received in the second arm 14 and rotatably supported by bearings (not labeled) placed therein, respectively.

The first and second motors 17, 18 can be mounted at the end of the second arm 14 away from the fifth axle 165 and sixth axle 166, such that it is unnecessary to arrange the first and second motors 17, 18 along the axes of the fifth and sixth axles 165, 166, respectively. Therefore, the extension along both the axes of the fifth and sixth axles 165, 166 is minimized, and the robot arm assembly 200 is thus compact.

In addition, loads on the fifth axle 165 applied by the second motor and speed reducer weight can be removed to facilitate control of the fifth axle and sixth axles 165, 166. Since the first and second gear transmissions 21, 23 each apply a multi-stage transmission, a predetermined gear ratio can be achieved, and the first and second gear transmissions 21, 23 can use standard gears, so that costs are conserved. Furthermore, the space occupied by the robot arm assembly 200 is further conserved due to the hollow structure of the second arm 14, allowing at least a partial reception of the first and second gear transmissions 21, 23 therein.

The operation of the robot arm assembly 200 is explained with reference to one embodiment. The operations of other motion components of the robot 100, such as the bracket 12 and first arm 13 are similar to a conventional robot, and description thereof is thus not given.

The control device 19 is programmable with control instructions therein. The first gear transmission 21 transmits the movement of the first motor 17 to the fifth axle 165 to rotate the fifth axle 165 around the rotating axis thereof, in response to the control instructions for the first motor 17. Simultaneously, the sixth axle 166 can follow the rotation of the fifth axle 165 to rotate around the axis of the fifth axle 165, and rotate around the axis of the sixth axle 166, because the pair of second bevel gears 236a, 236b meshes with each other, such that an error is produced (defining the error as a following rotation error here). In order to compensate the following rotation error, the sixth axle 166 rotates synchronously around the axis of the sixth axle 166 driven by the second gear transmission 23, in response to the control instruction for the second motor 18. Therefore, the sixth axle 166 can be kept in the current position while the fifth axle 165 is rotating. When independent control of the sixth axle 166 is required, the second motor 18 drives the sixth axle 166 via the second gear transmission 23 to a predetermined angle around the axis of the sixth axle 166, in response to instructions from the control device 19. The rotation of the sixth axle 166 does not change the position of the fifth axle 165, such that the sixth axle 166 can be positioned accurately by the control device 19 as described.

It should be understood that the first and second gear transmissions 21, 23 can also add or remove one or more gear transmission stages to achieve a predetermined gear ratio.

It should also be understood that the robot 100 is not limited to a six-axis industrial robot, and can alternatively be industrial robots with fewer axes, with the above-mentioned three axes well within the scope of the disclosure.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A robot arm assembly, comprising:
a supporting arm;
an Nth axle pivotally connected to the supporting arm, wherein N is an integer greater than or equal to 1;
an (N+1)th axle pivotally and substantially perpendicularly connected to the Nth axle;
a first motor;
a first gear transmission coupled to the first motor to drive the Nth axle;
a second motor;
a second gear transmission coupled to the second motor to drive the (N+1)th axle; and
a control device to control the first and second motors;
wherein the first and second gear transmissions are multi-stage gear transmissions; the first gear transmission comprises a first bevel gear coaxially aligned with and rigidly connected to the Nth axle, the second gear transmission comprises a second bevel gear coaxially aligned with and rigidly connected to the (N+1)th axle; as the Nth axle rotates around the axis of the Nth axle driven by the first motor via the first gear transmission, the (N+1)th axle rotates around the axis of the (N+1)th axle driven by the second motor via the second gear transmission to compensate a following rotation error caused by following the rotation of the Nth axle.

2. The robot arm assembly of claim 1, wherein the second arm is hollow with a substantially fork-like extension.

3. The robot arm assembly of claim 2, wherein the first and second motors are mounted on opposite sides of the support arm along the axial direction thereof to couple with the first and second gear transmissions, respectively.

4. The robot arm assembly of claim 2, wherein the first gear transmission comprises a first input gear, a first transmission shaft, a pair of first spur gears, and a pair of first bevel gears combined in series, and one of the first bevel gears is secured to the Nth axle.

5. The robot arm assembly of claim 4, wherein the transmission shaft is hollow and substantially cylindrical, and rotatably received in the support arm and supported by bearings placed therein.

6. The robot arm assembly of claim 5, wherein the first input gear is mounted at an end of the first transmission shaft away from the Nth axle, and coupled to the first motor; and one of the first spur gears is mounted at an end of the first transmission shaft adjacent to the Nth axle.

7. The robot arm assembly of claim 6, wherein the second gear transmission comprises a second input gear, a second transmission shaft, a pair of second spur gears, a pair of third bevel gears, and a pair of second bevel gears combined in series, and one of the second bevel gears is secured to the (N+1)th axle.

8. The robot arm assembly of claim 7, wherein the second transmission shaft is substantially cylindrical and rotatably received in the first transmission shaft, and rotatably supported by bearings placed therebetween.

9. The robot arm assembly of claim 8, wherein the second input gear is mounted at an end of the first transmission shaft away from the Nth axle, and coupled to an output shaft of the second motor; one of the second spur gears is mounted at an end of the second transmission shaft adjacent to the Nth axle.

10. The robot arm assembly of claim 9, wherein the first spur gears and the second spur gears are offset from each other in the axial direction.

11. The robot arm assembly of claim 9, wherein the first bevel gears and the third bevel gears are located on opposite sides of the first transmission shaft along the axial direction.

12. The robot arm assembly of claim 1, wherein the Nth axle is pivotally connected to the support arm and rotatably supported by bearings placed in the support arm.

13. The robot arm assembly of claim 12, wherein the Nth axle defines a first shaft hole to receive the (N+1)th axle, and a second shaft hole perpendicular to and communicating with the first shaft hole to receive the bevel gear meshing with the bevel gear secured to the (N+1)th axle.

14. An industrial robot, comprising:
a base;
a supporting arm pivotally connected to the base;
an Nth axle pivotally connected to the supporting arm, wherein N is an integer greater than or equal to 1;
an (N+1)th axle pivotally and substantially perpendicularly connected to the Nth axle;
a first motor;
a first gear transmission coupled to the first motor to drive the Nth axle;
a second motor;
a second gear transmission coupled to the second motor to drive the (N+1)th axle; and
a control device to control the first and second motors;
wherein the first gear transmission and the second gear transmission are multi-stage gear transmissions; the first gear transmission comprises a first bevel gear coaxially aligned with and rigidly connected to the Nth axle, the second gear transmission comprises a second bevel gear coaxially aligned with and rigidly connected to the (N+1)th axle; as the Nth axle rotates around the axis of the Nth axle driven by the first motor via the first gear transmission, the (N+1)th axle rotates around the axis of the (N+1)th axle driven by the second motor via the second gear transmission to compensate a following rotation error caused by following the rotation of the Nth axle.

15. The industrial robot of claim 14, wherein the industrial robot is a six-axis robot, wherein the Nth axle is the fifth axle and the (N+1)th axle is the sixth axle.

16. The industrial robot of claim 14, wherein the first gear transmission comprises a first input gear, a first transmission shaft, a pair of first spur gears, and a pair of first bevel gears combined in series, and one of the first bevel gears is secured to the Nth axle; the second gear transmission comprises a second input gear, a second transmission shaft, a pair of second spur gears, a pair of second bevel gears, and a pair of third bevel gears combined in series, and one of the second bevel gears is secured to the (N+1)th axle.

17. The industrial robot of claim 16, wherein the first spur gears and second spur gears are offset from each other in an axial direction.

18. The industrial robot of claim 16, wherein the first and third bevel gears are located on opposite sides of the first transmission shaft along the axial direction.

19. The industrial robot of claim 16, wherein the supporting arm is hollow with a substantially fork-like extension; and the first and second motors are mounted on opposite sides of the support arm along the axial direction thereof to couple to the first and second gear transmissions, respectively.

20. The industrial robot of claim 19, wherein the first and second gear transmissions are at least partly received in the support arm and rotatably supported by bearings placed therein, respectively.
